(19) United States
(12) Patent Application Publication
(10) Pub. No.: US 2012/0112086 A1
(43) Pub. Date: May 10, 2012

(54) SYSTEM AND METHOD FOR ESTIMATING CHANGE OF STATUS OF PARTICLE BEAMS

(75) Inventors: Kuen-Yu TSAI, Taipei (TW); Sheng-Yung Chen, Taipei (TW); Jia-Yush Yen, Taipei (TW); Yung-Yaw Chen, Taipei (TW); Chi-Hsiang Fan, Taipei (TW)

(73) Assignee: National Taiwan University, Taipei City (TW)

(21) Appl. No.: 13/287,290

(22) Filed: Nov. 2, 2011

Related U.S. Application Data
(60) Provisional application No. 61/410,295, filed on Nov. 4, 2010.
(60) Provisional application No. 61/431,063, filed on Jan. 10, 2011.

(51) Int. Cl. G01T 1/16; G01J 1/42

(52) U.S. Cl. 250/393; 250/208.2; 250/395

(57) ABSTRACT

This invention provides a system for estimating change of status of one or a plurality of particle beams, the system comprises a plurality of particle detectors and an estimating unit, wherein one or a plurality of particle beams is being projected to a substrate. The particle detectors detect the one or the plurality particle beams reflected from the substrate to generate one or a plurality of detected signals. The estimating unit estimates change of the status of the one or the plurality of particle beams according to the one or the plurality of detected signals. By such arrangement and estimating method, the system could estimate multiple beams and achieve beam placement accuracy.

### CROSS REFERENCE TO RELATED APPLICATIONS

This application claims the benefit of U.S. Provisional Application No. 61/410,295, filed on Nov. 4, 2010, and U.S. Provisional Application No 61/431,063, filed on Jan. 10, 2011, the contents of which are incorporated herein by reference.

### BACKGROUND OF THE INVENTION

1. Field of the Invention

The present invention relates to a system and a method for estimating change of status of one or a plurality of particle beams.

2. Description of the Prior Art

Microlithography, a process for transferring desired patterning information to a wafer, is one of the most critical processes in integrated circuit fabrication. Currently, the mainstream technology for high-volume manufacturing of integrated circuits utilizes optical projection lithography with 193 nm deep ultraviolet laser and water immersion. Its resolution, mainly limited by optical diffraction, has been pushed below 45 nm in half-pitch. However, associated mask complexity and cost have grown prohibitive partly because strong resolution enhancement techniques such as multiple patterning are required to compensate for the diffraction effects. Several next-generation lithography techniques are being investigated for the 22 nm half-pitch node and beyond. Electron beam lithography is one of the promising candidates to replace optical projection lithography because of its capability of high resolution and rnaskless operation.

Multiple-electron-beam-direct-write (MEBDW) lithography has been proposed and investigated to increase throughput. By utilizing micro-electromechanical system (MEMS) processes for fabricating electron optical systems, the dimension of an electron beam lithography system can be shrunk substantially. Theoretically, a massive amount of electron beams can be integrated and driven to expose the same wafer simultaneously. This architecture poses several engineering challenges to be conquered in order to achieve throughput comparable to optical projection lithography.

The beam quality of an electron beam lithography system can degrade due to various uncertain effects such as electron charging and stray field. In multiple-electron-beam systems, beam positioning drift problems can become quite serious due to heat dissipation and electron optical system (EOS) fabrication errors. Periodic recalibration with reference markers on the wafer has been utilized in single-beam systems to achieve beam placement accuracy.

However, it is difficult to extend technique of periodic recalibration for MEBDW because the complexity involves may increase significantly with beam numbers. Therefore, how to modify the current method and system for monitoring particle beams in MEBDW lithography as a method or a system which can monitor multiple-beams and achieve beam placement accuracy has become an imminent task for the industries,

### SUMMARY OF THE INVENTION

The disclosure is directed to a system and method for estimating change of status of particle beams. The reflected particle beams are detected by a plurality of particle detectors to generate a plurality of detected signals, and the estimating unit estimates change of status of the particle beams according to the detected signals so that the beam placement could be estimated more accuracy.

According to a first aspect of the present disclosure, a system for estimating change of status of one or a plurality of particle beams is provided.

The system includes a plurality of particle detectors and an estimating unit, wherein one or a plurality of particle beams is being projected to a substrate. The particle detectors detect one or the plurality of particle beams reflected from the substrate, to generate one or a plurality of detected signals. The estimating unit estimates change of the status of the one or the plurality of particle beams according to the one or the plurality of detected signals.

According to a second aspect of the present disclosure, a method for estimating change of status of one or a plurality of particle beams is provided. The method includes the following steps: providing one or a plurality of particle beams being projected to a substrate; detecting the one or the plurality of particle beams reflected from the substrate by a plurality of particle detectors to generate one or a plurality of detected signals; and estimating change of the status of the one or the plurality of particle beams according to the one or the plurality of detected signals.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1A shows a schematic view of a system for estimating change of status of one or a plurality of particle beams of the present invention.

FIG. 1B(I) shows a schematic view of a two-dimensional array of particle detectors.

FIG. 1B(II) shows a schematic view of a detector group grouped of the four particle detectors A-D.

FIG. 1B(III) is an enlarged schematic view of the detector group.

FIG. 2 is a diagram showing simulation results of collection efficiency with various working distances obtained from 10,000 electrons incident to a silicon substrate.

FIG. 3 shows a flow chart of a method for estimating change of status of a plurality of particle beams.

FIG. 4 is a schematic view showing the particle beam deviates from the original beam axis and drifts toward the particle detector 120 A.

FIG. 5 shows a simulation result of the detected signals versus departure.

FIG. 6 shows 36 particle detectors form a 3×3 detector groups where each detector group includes four particle detectors in its left side and a distribution of the captured backscattered electrons in its right side.

### DETAILED DESCRIPTION OF THE PREFERRED EMBODIMENTS

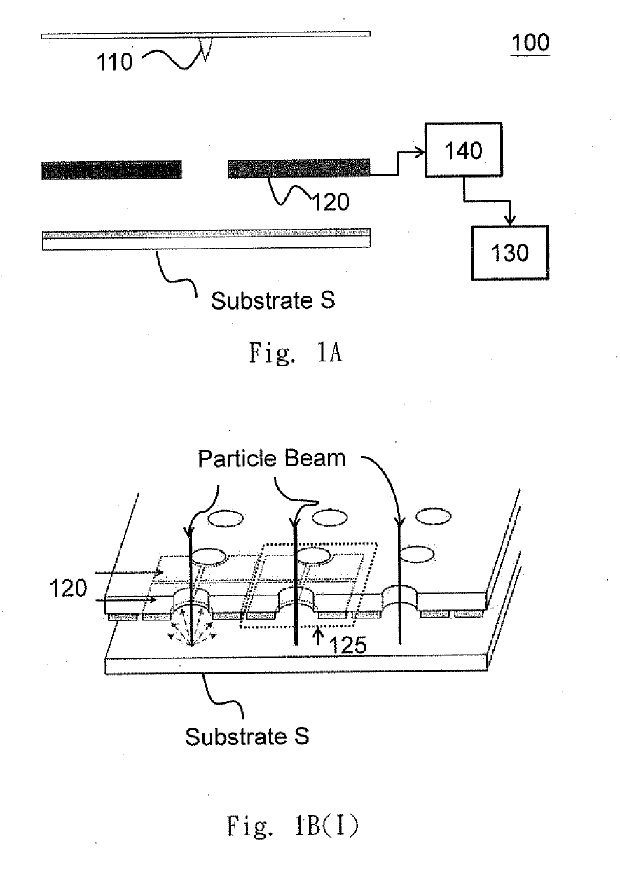

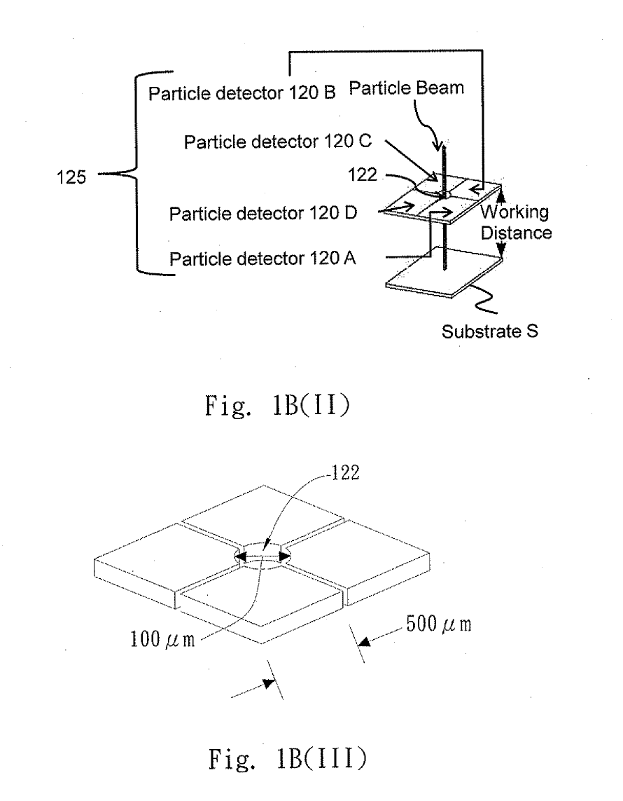

Referring to FIG. 1A, which shows a schematic view of a system 100 for estimating change of status of one or a plurality of particle beams of the present invention, wherein the particle beams are used for being projected to a substrate S. The system 100 includes a plurality of particle detectors 120 and an estimating unit 130. In one embodiment, the system 100 could further include a plurality of beam sources 110 and/or a signal amplification unit 140.

The beam sources 110, such as photon beams, electron beams, ion beams or any combination thereof, could receive a control signal to provide one or a plurality of particle beams being projected to a substrate 5, wherein the particle beams are substantially vertically projected to the substrate S.

The particle detectors 120, such as electron detectors, could detect the one or the plurality of particle beams reflected from the substrate S to generate one or a plurality of detected signals. In one embodiment, the particle detectors 120 could be disposed as an array of electron detectors placed above the substrate 5, e.g. a wafer. In another embodiment, the particle detectors 120 could be quadrant-form two-dimensional detectors.

The estimating unit 130, such as a processing unit, could estimates change of the status of the one or the plurality of particle beams according to the one or the plurality of detected signals. The status of the particle beams, for example, could be the number of the reflected particles, particle energy, particle flux, the size, the shape, the position or the attitude of the particle beams. In one embodiment, the status of one or each of the particle beams is detected by at least two of the plurality of particle detectors. In another embodiment, the status of one or each of the particle beams is detected by at least four of the plurality of particle detectors.

The signal amplification unit 140, such as a signal amplifier, can amplify the detected signals and transmit the amplified signals to the estimating unit 130, wherein the estimating unit 130 could estimate change of status of the one or the plurality of particle beams according to the amplified signals. In one embodiment, the signal amplification unit 140 could be disposed inside the estimating unit 130 or particle detectors 120.

In one embodiment, the particle detectors 120 are grouped, preferably every four of them are grouped, so as to form one or a plurality of detector groups 125, and the one or each of the particle beams is projected to the substrate S through a center part of one or each of the detector groups 125, such that the particle detectors 120 of the detector group 125 can sense the uneven backscattered distribution when the particle beam position is drifted from the central part. In another embodiment, the particle detectors 120, less than four or more than four, could be grouped to form one or a plurality of detector groups, and the one or each of the particle groups corresponds to the one or each of the particle beams respectively, wherein the estimating unit 130 estimates change of status of the one or the plurality of particle beams according to the plurality of detected signals transmitted from the one or each of the detector groups 125.

For example, referring to FIG. 1B(I), which shows a schematic view of a two-dimensional array of particle detectors 120 over the substrate 5, in which every four particle detectors 120 are grouped so as to form a plurality of detector groups 125. Please refer to FIG. 1B (II), which shows a schematic view of the detector group 125 grouped of the four particle detectors 120 A-D. The particle beam projects to the substrate S through a center part of the detector group 125. In one embodiment, the center part of the detector group 125 include a hole 122 for being passed by the particle beams.

Referring to FIG. 1B(III), which is an enlarged schematic view of the detector group, in which the hole 122, for example, could be set to 100 um, and the particle detectors could be set to 500 um while the beam pitch is 1 mm. The sensitivity of particle detectors 120 is increased with reduced cross-coupling effect due to larger beam pitch.

The particle detectors 120 can detect a distribution of back-scattered electrons. For each particle beam, the spatial distribution of back-scattered electrons depends on a distance between the ideal beam axis and the actual beam position; The ideal beam axis, for example, is an ideal path which particle beam projects. When a particle beam drifts to one side of the detector group gradually, some detectors of the detector groups may observe ascending signals, while other may observe descending signals. By comparing the magnitudes of detector signals, the value and direction of beam drift over time can be estimated. in one embodiment, each of the particle detectors 120 could has a non-planar surface to enhance reception sensitivity, such as the sensitivity for receiving the reflected particle beams.

Since the system 100 for estimating change of status of one or a plurality of particle beams is based on the detection of reflected particle beam, such as backscattered electrons, understanding the behavior of reflected particle beam is important. The main particle detector design objective is to collect as many electrons as possible. However, the size of the detector is miniaturized in order to be compatible with the miniaturized columns. The main design difficulty is that the signals become weaker as the size of the detector becomes smaller. Moreover, small size of particle detectors 120 will lead to more backscattered electrons out, of particle detector 120 range. Therefore, the cross-coupling effect becomes an important issue in multiple-beam case.

Back to FIG. 1B(II), a working distance is defined to be a distance from the substrate S to a sensitive area of the particle detectors 120. A lower limit of the working distance is needed to ensure safe substrate exposure. An upper limit of the working distance is restricted by a collection efficiency, which is defined to be a ratio between a number of backscattered electrons that can be collected and a total number of backscattered electrons. It is a key indicator for designing the detector array since the main target is to collect electrons as much as possible to improve signal strength. In one embodiment, the working distance is between 0.2 mm-0.7 mm. In another embodiment, the working distance is 0.5 mm.

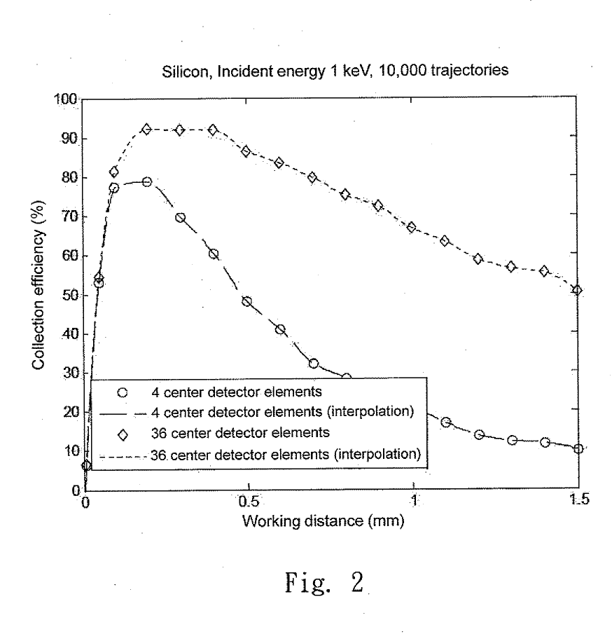

Refer to FIG. 2, which is a diagram showing simulation results of the collection efficiency with various working distances obtained from 10,000 electrons incident to a silicon substrate, wherein a beam spot size of the electrons is 10 nm and its incident energy is 1 keV. The result shows that the four detectors collection efficiency of the group detector 125 reaches its maximum of 80% when the working distance is about 0.2 mm. It is reduced to about 50% at 0.5 mm.

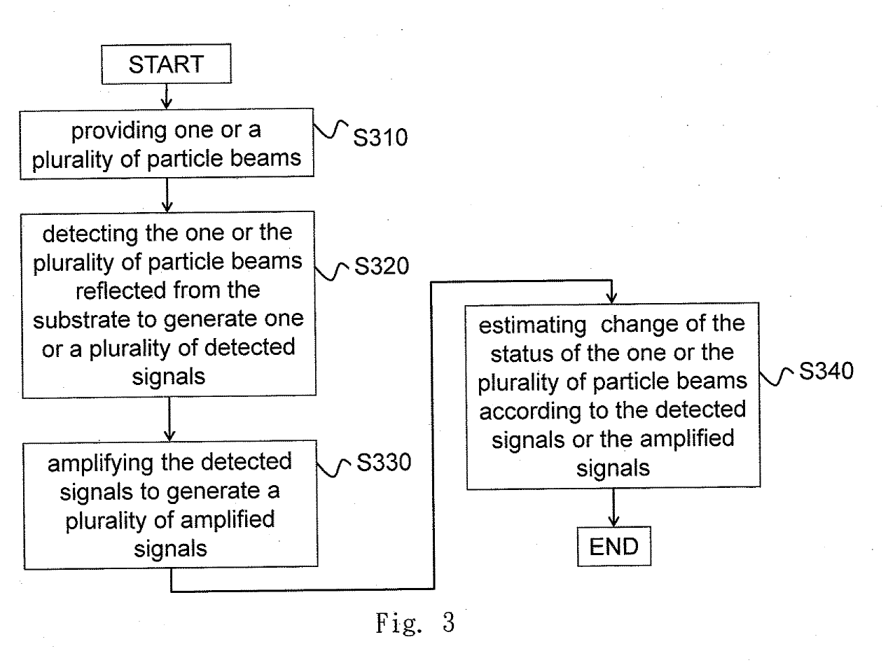

Refer to FIG. 3, which shows a flow chart of a method for estimating change of status of one or a plurality of particle beams 120, wherein the particle beams 120 are used for being projected to a substrate S. Please also refer to FIG. 1.

In step S310, one or a plurality of particle beams is provided by one or a plurality of beam sources 110. For example, the particle beam provided from the beam source 110 is projected through a hole of the group detector 125 to the substrate S.

In step S320, the one or the plurality of particle beams reflected from the substrate is detected by a plurality of particle detectors 120 to generate one or a plurality of detected signals. For example, refer to FIG. 1B(II), the reflected particle beams could be detected by particle detectors 120 A-D; however, in another embodiment, the reflected particle beams could be detected by other particle detectors 120 other than the particle detectors 120 A-D.

In step S330, the detected signals are amplified by a signal amplification unit 140 to generate a plurality of amplified signals. The signal amplification unit 140, for example, amplifies the detected signals according to the strength of the detected signals.

In step S340, change of the status of the one or the plurality of particle beams is estimated by the estimating unit 140 according to the detected signals or the amplified signals. In one embodiment, the system 100 could further includes the amplification unit 140, then the estimating unit 140 could receive the amplified signals transmitted from the signal amplification unit 140, and the estimating unit 140 would estimates change of the status according to the amplified signals. In another embodiment, the system 100 could not include the amplification unit 140, then the estimating unit 130 could estimate change of the status of the particle beams according to the detected signals transmitted from the particle detector 120.

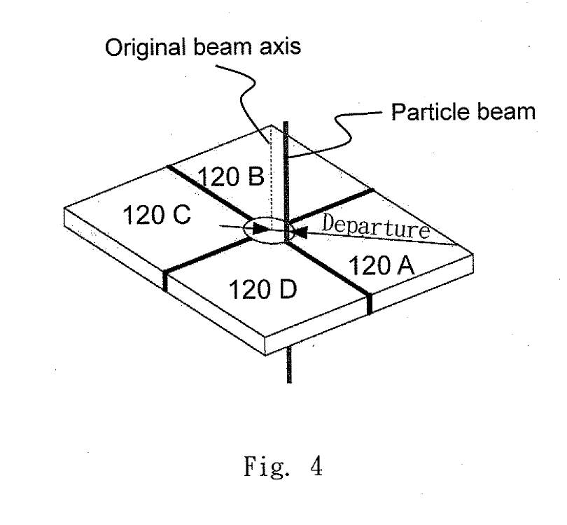

The status of the particle beams, for example, is a distance which the particle beam deviates from an original beam axis, wherein the particle beam may drift toward one particle detector 120. Refer to FIG. 4, which is a schematic view showing the particle beam deviates from the original beam axis and drifts toward the particle detector 120 A. The original beam axis passes through the central part of the detector group 125. In this example, the particle beam drifts toward the particle detector 120 A with a distance from 0 um to 50 um, the theoretical responsively of SPDs (Silicon Photodiode Detectors) with R_{A}=0.27 A/W¹⁰ is used, the working distance is set to 0.5 mm, and the incident current I_{O} is 10 nA.

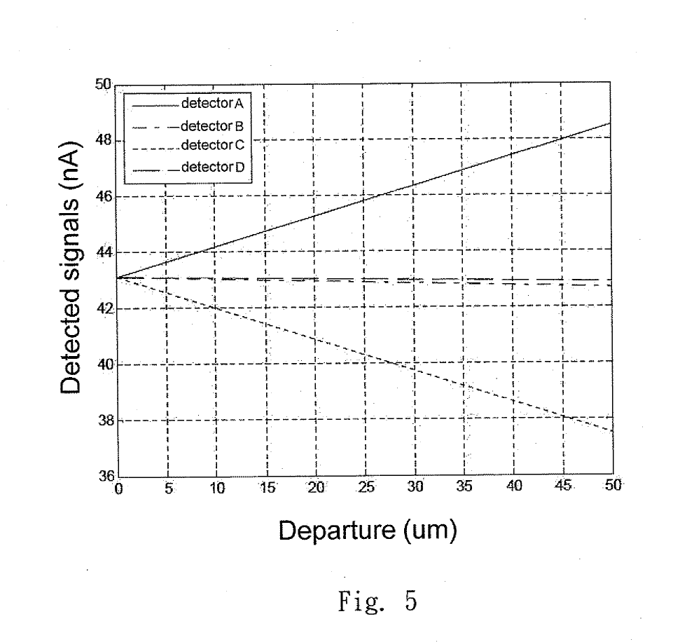

FIG. 5 shows a simulation result of the detected signals versus departures of the particle beam from the original beam axis. Due to symmetry, the signals from the particle detector 120 B and the particle detector 120 D are expected to be identical. The small difference is due to the stochastic effects of simulation. The detected signal of the particle detector 120 A increases from about 43 nA to about 48.5 nA with the departure from 0 um to 50 um. The detected signal of the particle detector 120C decreases from about 43 nA to about 37.5 nA. The difference sensitive is about 0.22 nA per micron.

In this embodiment, the four particle detectors 120 A-D grouped as the particle group 125 are disposed symmetrically such that two detected signals of the detector group 125 are substantially equal to each other, and an amount of difference of another two detected signals of the detector group 125 increases with increase of a distance between the particle beam and the center part of the detector group 125 when the particle beam drifts toward one of the four particle detectors 120, e.g. the particle detector 120A. That is, in this embodiment, the estimating unit 130 could estimate the drift status of the particle beam according to the amount of difference between detected signals of the particle detectors 120 A and 120C.

This simulation result helps to determine the preliminary specifications of the detectors circuits.

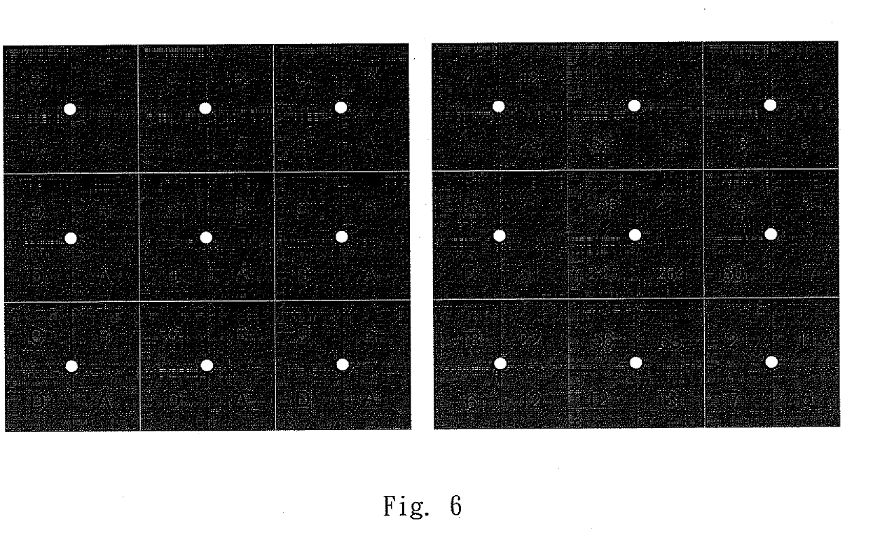

From FIG. 2, it is found that at least 20% of the electrons cannot be captured by the four particle detectors 120 of the group detector 125. It is expected that while some of the electrons of the particle beam are scattered back to the beam aperture, some will be captured by the particle detectors 120 originally designed for a nearby beam. This phenomenon contributes to the cross-coupling effects. In FIG. 6, whose left side shows 36 particle detectors 120 form a 3×3 group detectors where each group detector includes four particle detectors 120. It is studied to quantify the cross-coupling effects.

In this simulation, ten thousand electrons with 1 keV incident energy were simulated with the working distance set to 0.5 mm. As show in the right side of FIG. 6, the distribution of the captured backscattered electrons has a radial pattern shape. There are 7,957 (80%) electrons staying in the silicon substrate, and 2,043 (20%) backscattered electrons. 1,785 (87%) backscattered electrons are collected by the 36 particle detectors 120. Only 1,017 (256+272+225+264=1,017; 50%; 1% of total incident electrons) backscattered electrons are collected by the central-four particle detectors 120. 768 (37%) backscattered electrons are collected by the 32 nearby-beam particle detectors 120. 258 (13%) backscattered electrons fall out of the region of those 36 particle detectors 120. Zero to one (<0.05%) backscattered electron fall into the gaps between each elements and each holes. That is, the status of the particle beam could be estimated by one detector group 125, or by more than one detector groups 125 since the reflected particle beam would be detected by more than one detector groups 125.

According to the system and method for estimating change of status of one or a plurality of particle beams, wherein the status of the particle beams are estimated by a estimating unit according to the detected signals transmitted from the particle detectors, so the system and method of the present disclosure could be used in MEBDW lithography. Therefore, the system and method for estimating change of status of a plurality of particle beams of the disclosure at least has the feature of “could estimate multiple-beams and achieve beam placement accuracy”.

What is claimed is:

1. A system for estimating change of status of one or a plurality of particle beams, comprising:
one or a plurality of particle beams projected to a substrate;
a plurality of particle detectors, used for detecting the one or the plurality of particle beams reflected from the substrate to generate one or a plurality of detected signals; and
an estimating unit, used for estimating change of status of the one or the plurality of particle beams according to the one or the plurality of detected signals.

2. The system for estimating change of status of one or a plurality of particle beams of claim 1, wherein the status of the one or each of the plurality of particle beams is detected by at least two of the plurality of particle detectors.

3. The system for estimating change of status of one or a plurality of particle beams of claim 1, wherein the particle detectors are grouped so as to form one or a plurality of detector groups, the one or each of the particle groups corresponds to the one or each of the particle beams respectively, and the estimating unit estimates change of status of the one or the plurality of particle beams according to the one or the plurality of detected signals transmitted from the one or each of the detector groups.

4. The system for estimating change of status of one or a plurality of particle beams of claim 1, wherein the particle detectors are grouped so as to form one or a plurality of detector groups, the center part of the one or each of the detector groups includes a hole, the one or each of the plurality of particle beams projects through the hole of the center part of the one or each of the detector groups, and the plurality of particle detectors are disposed symmetrically.

5. The system for estimating change of status of one or a plurality of particle beams of claim 1, wherein the status of the one or the plurality of particle beams represents the number of the reflected particles.

6. The system for estimating change of status of one or a plurality of particle beams of claim 1, wherein the status of the one or the plurality of particle beams represents the particle energy or the particle flux of the one or each of the particle beams.

7. The system for estimating change of status of one or a plurality of particle beams of claim 1, wherein the status of the one or the plurality of particle beams represents the size, the shape, the position, or the attitude of the one or each of the particle beams.

8. The system for estimating change of status of one or a plurality of particle beams of claim 1, further comprising:
a signal amplification unit, used for amplifying the detected signals to generate a plurality of amplified signals, wherein the estimating unit estimates change of status of the one or the plurality of particle beams according to the amplified signals.

9. The system for estimating change of status of one or a plurality of particle beams of claim 1, wherein each of the particle detectors has a non-planar surface to enhance reception sensitivity.

10. The system for estimating change of status of one or a plurality of the particle beams of claim 1, wherein the particle beams are photon beams, electron beams, ion beams or any combination thereof.

11. A method for estimating change of status of one or a plurality of particle beams, comprising:
projecting one or a plurality of particle beams to a substrate;
detecting the one or the plurality of particle beams reflected from the substrate by a plurality of particle detectors to generate one or a plurality of detected signals; and
estimating change of status of the one or the plurality of particle beams according to the one or the plurality of detected signals.

12. The method for estimating change of status of one or a plurality of particle beams of claim 11, wherein the status of the one or the plurality of particle beams is detected by at least two of the plurality of particle detectors.

13. The method for estimating change of status of one or a plurality of particle beams of claim 11, wherein the particle detectors are grouped so as to form one or a plurality of detector groups, the one or each of the particle groups corresponds to the one or each of the particle beams respectively, and the estimating unit estimates change of status of the one or the plurality of particle beams according to the plurality of detected signals transmitted from the one or each of the detector groups.

14. The method for estimating change of status of one or a plurality of particle beams of claim 11, wherein the particle detectors are grouped so as to form one or a plurality of detector groups, the center part of the one or each of the detector groups includes a hole, the one or each of the plurality of particle beams projects through the hole of the center part of the one or each of the, detector groups, and the plurality of particle detectors are disposed symmetrically.

15. The method for estimating change of status, of one or a plurality of particle beams of claim 11, wherein the status of the one or the plurality of particle beams represents the number of the reflected particles.

16. The method for estimating change of status of one or a plurality of particle beams of claim 11, wherein the status of the one or the plurality of particle beams represents the particle energy or the particle flux of the one or each of the particle beams.

17. The method for estimating change of status of one or a plurality of particle beams of claim 11, wherein the status of the one or the plurality of particle beams represents the size, the shape, the position or the attitude of the one or each of the particle beams.

18. The method for estimating change of status of one or a plurality of particle beams of claim 11, further comprising:
amplifying the detected signals by a signal amplification unit to generate a plurality of amplified signals, wherein the estimating unit estimates change of status of the one or the plurality of particle beams according to the amplified signals.

19. The method for estimating change of status of one or a plurality of particle beams of claim 11, wherein each of the particle detectors has a non-planar surface to enhance reception sensitivity.

20. The method for estimating change of status of one or a plurality of particle beams of claim 11, wherein the particle beams are photon beams, electron beams, ion beams or any combination thereof.
